(19) United States
(12) Patent Application Publication
(10) Pub. No.: US 2020/0294045 A1
(43) Pub. Date: Sep. 17, 2020

(54) INTERACTION PROCESSING SYSTEM AND METHOD

(71) Applicants: Kelvan Howard, San Francisco, CA (US); Michelle Winters, Belmont, CA (US); Michael Steven Bankston, Oakland, CA (US)

(72) Inventors: Kelvan Howard, San Francisco, CA (US); Michelle Winters, Belmont, CA (US); Michael Steven Bankston, Oakland, CA (US)

(21) Appl. No.: 16/299,572

(22) Filed: Mar. 12, 2019

(51) Int. Cl. G06Q 20/40; G06Q 30/06; G06Q 20/22; G06Q 20/06

(52) U.S. Cl. CPC G06Q 20/40; G06Q 30/0617; G06Q 20/38215; G06Q 20/06; G06Q 20/223

(57) ABSTRACT

Methods and systems disclosed herein relate to managing an interaction between a sender and one or more receivers. The system may receive an assent request message specifying one or more receivers and/or resources. The system may transmit assent request notification(s) to the receiver(s), via temporary resource provider interfaces, messages, and/or social network interfaces. A subset of the receivers may commit to receiving a resource. The receivers may be validated via a trusted identity database. If a receiver has a valid interaction assertion in the database, then the system may generate an interaction credential for the receiver and a commitment object. The system may process data to facilitate the transfer of the resource. Upon the receiver receiving the resource, the interaction credential may be redeemed. The system may cease availability of the temporary resource provider interfaces after a predetermined time after the sender leaves an arbitrary location.

### CROSS-REFERENCES TO RELATED APPLICATIONS

None.

### BACKGROUND

Peer-to-peer interactions between parties are increasingly common. Such interactions may vary between unstructured (e.g., a party asks a friend to pick her up a sandwich) to structured (e.g., a party buys and pays for furniture on an online marketplace). Typically, one or both of the parties puts themselves at risk in the interaction. If Joe buys goods for Mary with an expectation of being reimbursed, but Mary doesn't pay, then Joe may suffer a loss. If Mary were to pay up front, and Joe were to fail to buy the goods, then Mary may suffer a loss.

Some methods exist for providing reassurance to parties in an interaction. A temporary hold may be placed on a payment account until a transaction has been completed (e.g., until a user checks out of a hotel or receives an order in the mail). Funds may be placed in escrow and held by a third-party until a transaction has been completed (e.g., until a buyer has taken possession of a house). However, such methods are undesirable to a buyer. Holding funds may hamper the buyer's ability to conduct other transactions while the funds are held. This is particularly problematic for the buyer if the deal falls through—the buyer may have been unable to access the funds for a period without ever receiving a resource in exchange.

Further, structured interactions are generally limited to closed-loop systems. For example, parties may need to work within the confines of a particular platform, such as an online marketplace, to broker an interaction. Parties may be dissuaded by the extra steps of navigating to, and logging in to, such platforms. Working within just one such platform can limit the number of potential parties available to conduct an interaction.

Embodiments of the disclosure address these and other problems individually and collectively.

### BRIEF SUMMARY

Embodiments of the disclosure include methods as well as systems for managing interactions in a trusted, open-loop fashion.

One embodiment of the disclosure is directed to a method comprising: receiving, by a server computer from a sender device operated by a sender, an assent request message comprising a set of receivers, a sender identifier, and resource characteristics corresponding to a resource; transmitting, by the server computer to a set of receiver devices, each receiver device, of the set of receiver devices, corresponding to a receiver, of the set of receivers, an assent request notification comprising at least a subset of the resource characteristics; receiving, by the server computer from at least a subset of the set of receiver devices, a plurality of commitment response messages to commit to receiving the resource, wherein each commitment response message, of the plurality of commitment response messages, comprises a receiver identifier, of a plurality of unique receiver identifiers; for at least one commitment response message, of the plurality of commitment response messages: searching, by the server computer, an identity database for the receiver identifier; based on the receiver identifier, determining, by the server computer, whether a valid interaction assertion exists for the receiver; if the valid interaction assertion exists for the receiver, creating, by the server computer, an interaction credential for the receiver; generating, by the server computer, a commitment object, the commitment object comprising the resource characteristics, the sender identifier, the receiver identifier, and a sequence identifier unique to the commitment object; and transmitting, by the server computer, a notification of commitment to the sender.

Another embodiment is directed to a system comprising a server computer programmed to perform the above-noted method.

Another embodiment is directed to a method comprising: receiving, by a server computer from a sender device operated by a sender at an arbitrary location of a resource provider, of a plurality of resource providers, an assent request message comprising an indication of a plurality of resources at the resource provider; automatically creating, by the server computer, in response to the assent request message, a temporary resource provider module; providing, by the server computer, a plurality of temporary resource provider interfaces to a plurality of receiver devices in communication with the sender device; receiving, by the server computer, one or more commitment response messages from a set of receiver devices to commit to receiving resources, of the plurality of resources; processing, by the server computer, data to facilitate transfer of the resources to a set of receivers corresponding to the set of the receiver devices; and removing, after a predetermined time after the sender leaves the arbitrary location, by the server computer, an ability to access the temporary resource provider interfaces from that plurality of receiver devices.

Further details regarding various embodiments can be found in the Detailed Description and the Figures.

### BRIEF DESCRIPTION OF THE DRAWINGS

The example embodiment(s) of the present disclosure are illustrated by way of example, and not in way by limitation, in the figures of the accompanying drawings and in which like reference numerals refer to similar elements and in which:

FIG. 1 is a schematic diagram of a system according to some embodiments.

FIG. 2A is a schematic diagram of an identity database according to some embodiments;

FIG. 2B is a schematic diagram of an interaction management computer according to some embodiments.

FIGS. 3A-3B are a flow diagram for a method for managing an interaction for a resource according to some embodiments.

FIG. 4 is a flow diagram for a method for managing an interaction for a plurality of resources according to some embodiments.

FIG. 5 is an example interface according to some embodiments.

FIG. 6 is another example interface according to some embodiments.

While each of the figures illustrates a particular embodiment for purposes of illustrating a clear example, other embodiments may omit, add to, reorder, and/or modify any of the elements shown in the figures.

### DETAILED DESCRIPTION

### Definitions

Prior to discussing various embodiments, some terms can be described in further detail.

A “user” may include an individual. In some embodiments, a user may be associated with one or more personal accounts and/or user devices. The user may also be referred to as a cardholder, account holder, or consumer in some embodiments.

A “user device” may be any suitable device that may be operated by a user. User devices may include cellular phones, personal digital assistants (PDAs), pagers, tablets, personal computers, and the like. As additional examples, user devices may include wearable devices (e.g., watches, rings, etc.). A user device may comprise any suitable hardware and software for performing such functions, and may include multiple devices or components.

A “resource provider” may be an entity that can provide a resource such as goods, services, information, and/or access. Examples of resource providers includes merchants, data providers, transit agencies, governmental entities, venue and dwelling operators, etc. A resource provider may operate a resource provider computer.

A “merchant” may typically be an entity that engages in transactions and can sell goods or services, or provide access to goods or services.

An “authorizing entity” may be an entity that authorizes a request. Examples of an authorizing entity may be an issuer, a governmental agency, a document repository, an access administrator, etc. An authorizing entity may operate an authorization computer.

An “issuer” may typically refer to a business entity (e.g., a bank) that maintains an account for a user. An issuer may also issue payment credentials stored on a user device, such as a cellular telephone, smart card, tablet, or laptop to the consumer.

“Authorization processing” or “authorization operations” may include at least determining whether to authorize a transaction. Authorization processing may be executed responsive to receiving a notification that a prior step in a transaction has been completed. Alternatively, or additionally, authorization processing may include generating and sending an authorization request message and/or authorization response message.

An “authorization request message” may be an electronic message that requests authorization for a transaction. In some embodiments, it is sent to a transaction processing computer and/or an issuer of a payment card to request authorization for a transaction. An authorization request message, according to some embodiments, may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. point of sale equipment) that indicates approval of the transaction. The code may serve as proof of authorization.

The term “authentication” and its derivatives may refer to a process by which the credential of an endpoint (including but not limited to applications, people, devices, processes, and systems) can be verified to ensure that the endpoint is who they are declared to be.

“Transaction data” or “transaction details” may refer to information associated with a transaction. For example, transaction data may include one or more of an authorized amount (e.g., transaction amount, item value, etc.), other amount, terminal country code, terminal verification results, transaction currency code, transaction date, transaction type (e.g., card-present transaction, card-not-present transaction, high value transaction, low value transaction, local transaction, international transaction, etc.), an unpredictable number, application interchange profile (AIP), application transaction counter (ATC), issuer application data (IAD), etc.

The term “validation” may include the act of checking or affirming that information is legitimate. An example may be the act of checking that a digital signature appended to an electronic record is, in fact, legitimate and was signed by the entity that alleges creation of the digital signature. In some embodiments, digital signatures may be validated according to a verification algorithm in conjunction with a signing entity's public key. In other cases, if underlying data was signed using a symmetric key of a symmetric key pair, the signature can be validated with the corresponding symmetric key.

A “digital identity” (DI) may refer to a secure set of information about an entity (e.g., a person, organization, or thing). The DI may, in turn, be made available to another entity in a secure manner. Dls may rely on agreements among stakeholders and security measures such as cryptography.

An “assertion” may refer to a secure fact about an entity. For example, an assertion may specify something about an entity, such as whether the entity should be allowed to rent a car. An assertion may be secured cryptographically. An assertion may be digitally signed by the entity of interest and/or the trusted party providing the secure facts.

A “key” may refer to a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “public key” may include a cryptographic key that that forms a public key of a public/private key pair. The public key may be designed to be shared (e.g., transmitted between entities) and may be configured such that any information encrypted with the public key may only be decrypted using a private key associated with the public key.

A “private key” may include a cryptographic key that forms a private key of a public/private key pair. A private key may be used to decrypt data encrypted with a public key.

A “distributed ledger” may refer to a database that is shared among multiple nodes across a network. Entities corresponding to each node may store identical copies of the ledger at a given time. The entities may have permission to make changes or additions to the ledger. When the ledger is changed, the participating entities may receive the updated ledger.

The term “message” may include any data or information that may be transported from one entity to another entity (e.g., one computing device to another computing device). Messages may be communicated internally between devices/components within a computer or computing system or externally between devices over a communications network. Additionally, messages may be modified, altered, or otherwise changed to comprise encrypted or anonymized information.

As used herein, a “notification” may include a message that can be sent to an entity to provide information to the entity, such as a status associated with an event. The notification may include additional information about the event such as a time, date, a description of the event, participants of the event, etc. In some embodiments, a notification or notification message may inform an entity that the entity should perform one or more operations in association with an event.

The term “identifier” may refer to any information that may be used to identify information. In some embodiments, the identifier may be a special value generated randomly or according to a predetermined algorithm, code, or shared secret. For example, an individual may be identified using a driver's license number or a cryptographic key. In some embodiments, the identifier may be one or more graphics, a token, a bar code, a QR code, or any other information that may be used to uniquely identify an entity.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer-readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

### Systems

System Overview

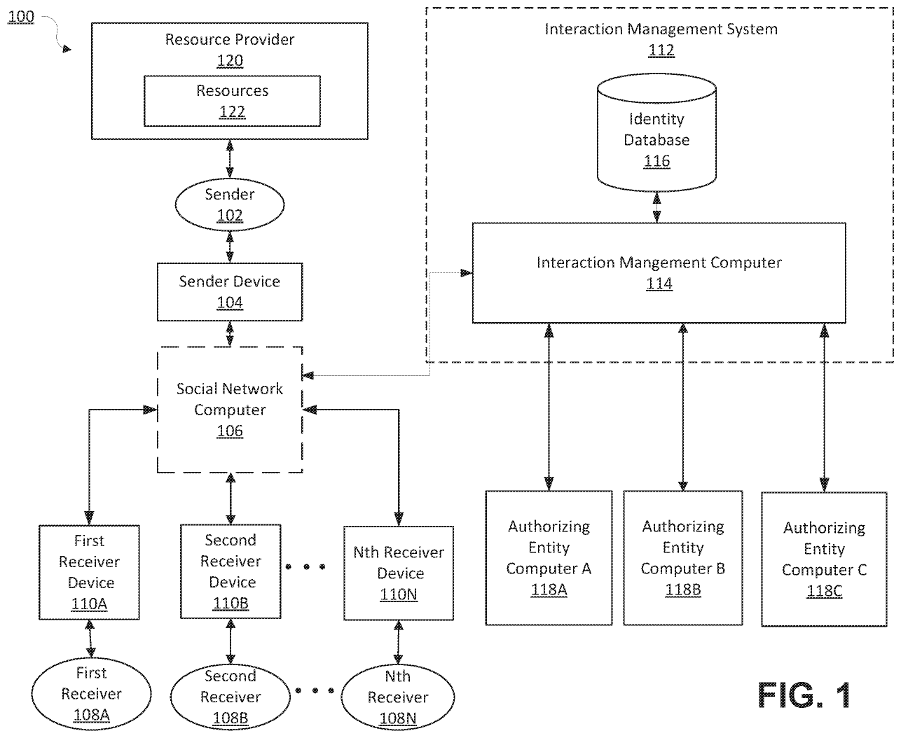

Referring now to FIG. 1, a schematic diagram of an example system 100 for managing interactions between a sender and one or more receivers is shown according to a non-limiting embodiment. An interaction may comprise a sender transmitting an assent request message, for assenting to receive a resource in exchange for something, which may result in receipt of commitment responses from one or more receivers. The interaction may further comprise the sender providing the resource to the receiver(s), and retrieval of something of value from the receiver(s) in exchange.

System 100 illustrates only one of many possible arrangements of components configured to execute the programming described herein. Other arrangements may include fewer or different components, and the division of work between the components may vary depending on the arrangement.

The system 100 can include at least one resource provider 120, a sender 102, a sender device 104, a social network computer 106, a plurality of receivers 108A, 108B, . . . 108N, a plurality of receiver devices 110A, 1106, . . . 110N, an interaction management computer 114, an identity database 116, and a plurality of authorizing entity computers 118A, 1186, 118C. Some or all of the components and devices of the system 100 may all be in operative communication with each other through a communication network and/or through short-range communication channels.

The communication network may include any suitable communication medium. The communication network may be one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Message between the entities, providers, networks, and devices illustrated in FIG. 1 may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The resource provider 120 may be an entity that can provide a resource, such as a merchant, data provider, transit agency, etc. The resource provider 120 may be associated with a physical location or a website.

A resource 122 may be something of value that can be passed from one entity to another. For example, a resource 122 may be a good, service, information, and/or access.

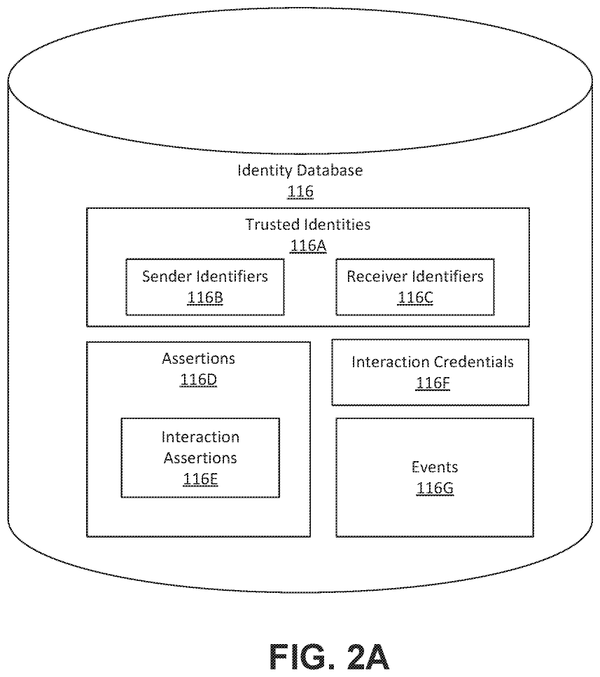

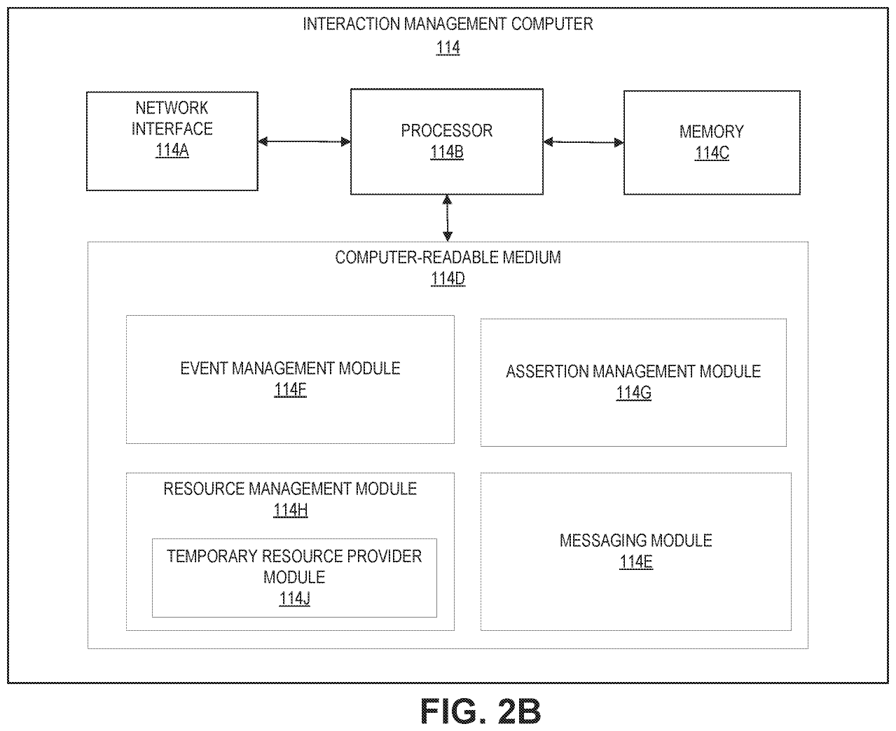

A sender 102 may be an entity, such as a user, offering a resource 122. Alternatively, or additionally, the sender 102 may be another resource provider. The sender 102 may offer one or more resources 122 to a plurality of receivers. In some embodiments, the resources 122 may be on offer at the resource provider 120 when the offer is made by the sender 102. The sender 102 may be associated with a sender identifier 1166, as further detailed below with respect to FIG. 2A.

The receivers (e.g., first receiver 108A, second receiver 108B, . . . Nth receiver 108N) may be entities, such as users, to potentially receive a resource 122. Each receiver may be associated with a respective receiver identifier 116C, as further detailed below with respect to FIG. 2A.

The sender device 104 may be a device operable by a user and capable of executing applications. As examples, the sender device 104 may be a smartphone, a computer, a tablet, or the like. The sender device 104 may include functionality for determining a location, such as Global Positioning System (GPS) capabilities. The sender device 104 may also include a camera. The sender device 104 may also include functionality to receive user input (e.g., touchscreen, keyboard, voice recognition functionality, etc.). The sender device 104 may also include functionality to generate and transmit assent request messages.

An assent request message may be a message establishing conditions for an interaction. The assent request message may correspond to a request, to one or more receivers, to assent to entering into the interaction. Such interactions may correspond to a sender obtaining a resource, directly or via a resource provider 120. For example, sender 102 may buy 20 shirts from a merchandise table at a concert. As another example, the sender may bake pies to order based on a number of receiver responses. The interactions may further correspond to the sender providing the resource to one or more receivers.

An assent request message may comprise information including a set of receivers, a sender identifier, and resource characteristics corresponding to a resource. The set of receivers may represent a network of the sender, in whole or in part. As examples, the sender may select (e.g., via a user interface) an option to select all members of a network, select particular members of a network, or deselect particular members of a network. The resource characteristics may describe the resource. As an example, the sender may specify that the sender wishes to offer for sale concert T-shirts for a particular band for $50 each. The resource characteristics may include the type of the resource (e.g., “T-shirt”), additional detail about the resource (e.g., the color of the shirt, the name of the band, the size of the shirt, etc.), and the price of the resource (e.g., $50). The assent request message may specify a period of time. For example, the assent request message may correspond to an offer which is open for six hours.

The receiver devices (e.g., first receiver device 110A, second receiver device 110B, . . . Nth receiver device 110N) may be devices operable by a user and capable of executing applications. As examples, the receiver devices may include smartphones, computers, tablets, etc. The receiver devices may include functionality to receive user input (e.g., touchscreen, keyboard, voice recognition functionality, etc.). The receiver devices may also include functionality to generate and transmit commitment response messages.

A commitment response message may correspond to an affirmative response to an assent request message, whereby the receiver is committing to receive a resource in exchange for something. For example, a receiver may click a link to indicate that she wishes to receive a band T-shirt for $20. The commitment response message may include a receiver identifier corresponding to the receiver.

The social network computer 106 may be a server computer for managing a social network. The social network computer 106 may host profiles for various entities, including the sender 102, first receiver 108A, second receiver 108B, and/or Nth receiver 108N. The social network computer 106 may include functionality to cause display, on the sender device 104 and receiver devices 110A, 110B, . . . 110N, of interface elements for sharing content amongst the entities. For example, the social network computer 106 may include functionality to cause display of images, text, links, and the like, based on user instructions. Accordingly, users may share content with a network of other users via the social network computer 106. Alternatively, in some embodiments, such functionality may be performed directly by the interaction management computer 114.

The interaction management computer 114 may be a server computer configured to facilitate interactions for providing resources between the sender 102 and one or more receivers 108A, 108B, . . . 108N. The interaction management computer 114 is described in detail below with respect to FIG. 2B.

The identity database 116 may be a be a storage unit and/or device (e.g., a file system, database, collection of tables, or other storage mechanism) for storing data. The identity database 116 is described in detail below with respect to FIG. 2A.

The identity database 116 and the interaction management computer 114 may be collectively referred to as interaction management system 112.

An authorizing entity computer (e.g., authorizing entity computer A 118A, authorizing entity computer B 118B, and authorizing entity computer C 118C) may be a computer, such as a server computer, controlled by an authorizing entity. The authorizing entity computers may execute authorization processing operations to determine whether to authorize a transaction. The authorizing entity computers may receive authorization request messages and transmit authorization response messages.

Identity Database

FIG. 2A illustrates an example identity database 116. The identity database 116 may be a storage unit and/or device for storing data. The identity database 116 may include multiple different storage units and/or devices. The identity database 116 may store trusted identities 116A, assertions 116D, interaction credentials 116F, and events 116G.

A trusted identity 116A may correspond to a data set associated with a particular entity. The trusted identities 116A may be stored in association with identifiers of the respective entities (e.g., sender identifiers 116B and receiver identifiers 116C). The sender identifiers 116B and the receiver identifiers 116C may, for example, be identification numbers, cryptographic keys (e.g., public keys), or user names. A sender identifier 116B may include data associated with a digital signature and/or cryptographic key of the sender. A receiver identifier 116C may include data associated with a digital signature and/or cryptographic key of the receiver. The set of users with information in the identity database 116 may be referred to as a “trusted identity network.”

An assertion 116D may correspond to an answer to a particular question. The question may be of the type that can be answered with a true/false or yes/no statement. As an example, an assertion 116D may specify whether a person has a valid payment account with a particular amount of funds available. As another example, an assertion 116D may specify whether a person is a United States citizen. As another example, an assertion 116D may specify whether a person is at least 21 years old. An assertion may further include supplemental data such as a time the assertion was generated, the source of the information used to generate the assertion, etc.

Assertions 116D may have restricted access. For example, an assertion 116D may be disclosed to only certain types of parties on a need-to-know basis (e.g., a government entity can access an assertion to determine whether a person is a United States Citizen, but not payment information; a merchant can access an assertion to determine whether a person has a valid payment account, but not citizenship information. Assertions 116D may be packaged into groups tailored to a particular recipient (e.g., a bar can access a package of assertions to determine whether (a) a user has a valid payment account and (b) whether a user is at least 21 years of age).

An interaction assertion 116E may be an assertion whether the entity has a valid payment account on file. Additionally, an interaction assertion 116E may specify whether funds are available in the payment account (e.g., at least $5 or at least $50). An interaction assertion 116E may further specify whether a particular type of payment account is on file (e.g., a bank account, a line of credit, etc.). In some embodiments, an identifier associated with such an account may be tokenized prior to being stored, and referred to as a “payment token.”

An interaction credential 116F may indicate that a receiver has agreed to, and is able to, exchange something of value for a particular resource. As an example, if a receiver enters into a commitment to buy a throw pillow from a sender for $20, the interaction management system 112 may generate an interaction credential 116F in the form of a limited-use payment token which the sender can redeem for $20 once the throw pillow has been delivered to the receiver. Redeeming an interaction credential 116F may comprise initiating payment processing (e.g., pulling $20 from the receiver's checking account). Alternatively, or additionally, the interaction credential may represent an assurance that the receiver will perform some action (e.g., post a picture on social media wearing a received shirt). An interaction credential 116F may be restricted based on time. For example, if the receiver does not receive the throw pillow within 5 days, then the interaction credential 116F expires and cannot be redeemed.

In some embodiments, the interaction management computer may execute operations in order to ensure that the receiver provides the agreed-upon value. As an example, if a first attempt to process payment fails, then the interaction management computer may periodically repeat payment processing operations until the necessary funds are retrieved. As another example, if the receiver does not provide the agreed-upon payment or action, then the interaction management computer may initiate a lien on an account or property of the receiver. As another example, if the receiver does not provide the agreed-upon payment or action, then the interaction management system may remove the receiver from the trusted identity database or associate a flag or demerit with the identity data stored for the receiver.

An event 116G may correspond to a stage in an interaction. For a particular event 116G, the interaction management system 112 may store event data such as the parties involved, a type of the event, a timestamp, etc.

The events 116G may include events corresponding to assent requests. For example, when a sender transmits an assent request message, the interaction management system 112 may generate, and store in the identity database 116, an assent request event. The assent request event data may include information such as resource characteristics, a sender identifier, a timestamp, etc.

The events 116G may include commitment events corresponding to a commitment response. For example, when a receiver commits to purchase a resource, the interaction management system 112 may generate a commitment object comprising the resource characteristics, the sender identifier, the receiver identifier, etc. The interaction management system 112 may further generate a sequence identifier unique to the commitment object. The sequence identifier may be a numerical value, cryptographic key, or the like. The sequence identifier may be used to manage the interaction. The interaction management system 112 may generate and store a commitment event corresponding to the commitment object.

The events 116G may include events corresponding to a confirmation of receipt of a resource. For example, when a dress is delivered to the residence of a receiver, the interaction management system 112 may generate and store an event to the identity database 116.

The events 116G may include events corresponding to a request for information. For example, an event may correspond to a request for user data in association with a transaction.

In some embodiments, information about each event 116G may be encrypted using a set of cryptographic keys. Information about an event 116G may, for example, be encrypted using a cryptographic key of the sender and/or a cryptographic key of the receiver. An event 116G may further be encrypted with cryptographic keys assigned to other entities, such as one or more third-party facilitators or technology providers (e.g., financial transaction processors, authorizing entities, social networks, etc.).

The events 116G may be used to access information for tasks such as dispute resolution, fraud detection, and/or analysis of user behaviors. For example, the interaction management system may identify a stored event to determine whether money was sent in the course of an interaction.

Access to the events may be restricted (e.g., via cryptographic keys distributed to entities and required to access one or more events). For example, a private key held by a receiver may be required to access event data, ensuring that event data is only available with explicit permission from the receiver. Access paths to the event data may be defined via a common application programming interface (API) structure. The access paths may be established such that limited entities may access the events with limited amounts of data.

In some embodiments, the identity database may include and/or be communicatively coupled to a distributed ledger. For example, the assertions 116D and/or events 116G may be stored to one or more distributed ledgers. A distributed ledger may be implemented, for example, as an Ethereum blockchain, which is supported by the Ethereum Foundation (https://www.ethereum.org/). As another example, a distributed ledger may be implemented as a Hyperledger, which is an open-source Linux Foundation project (https://www.hyperledger.org/).

Interaction Management Computer

Referring now to FIG. 2B, the interaction management computer 114 may include hardware and/or software configured to manage interactions between a sender and one or more receivers. The interaction management computer 114 may include a processor 114B operatively coupled to a network interface 114A, a memory 114C, and a computer-readable medium 114D.

The processor 114B may be implemented as one or more integrated circuits (e.g., one or more single core or multicore microprocessors and/or microcontrollers). The processor 114B may be used to control the operation of the interaction management computer 114. The processor 114B can execute a variety of programs in response to program code or computer-readable code stored in memory 114C. The processor 114B may include functionality to maintain multiple concurrently executing programs or processes.

The network interface 114A may be configured to connect to one or more communication networks to allow the interaction management computer 114 to communicate with other entities such as the sender device 104, the social network computer 106, the receiver devices (110A, 1106, . . . 110N), the authorizing entity computers (118A, 118B, 118C), etc. For example, communication with the interaction management computer 114 can be direct, indirect, and/or via an API.

The memory 114C may be implemented using any combination of any number of non-volatile memories (e.g., flash memory) and volatile memories (e.g., DRAM, SRAM), or any other non-transitory storage medium, or a combination of media.

The computer-readable medium 114D may comprise one or more non-transitory media for storage and/or transmission. Suitable media include, as examples, a random access memory (RAM), a read only memory (ROM), a magnetic medium such as a hard-drive or a floppy disk, or an optical medium such as a compact disk (CD) or DVD (digital versatile disk), flash memory, and the like. The computer-readable medium 114D may be any combination of such storage or transmission devices.

In some embodiments, the computer-readable medium 114D comprises code, executable by the processor 114B, to implement a method comprising: receiving, by a server computer from a sender device operated by a sender, an assent request message comprising a set of receivers, a sender identifier, and resource characteristics corresponding to a resource; transmitting, by the server computer to a set of receiver devices, each receiver device, of the set of receiver devices, corresponding to a receiver, of the set of receivers, an assent request notification comprising at least a subset of the resource characteristics; receiving, by the server computer from at least a subset of the set of receiver devices, a plurality of commitment response messages to commit to receiving the resource, wherein each commitment response message, of the plurality of commitment response messages, comprises a receiver identifier, of a plurality of unique receiver identifiers; for at least one commitment response message, of the plurality of commitment response messages: searching, by the server computer, an identity database for the receiver identifier; based on the receiver identifier, determining, by the server computer, whether a valid interaction assertion exists for the receiver; if the valid interaction assertion exists for the receiver, creating, by the server computer, an interaction credential for the receiver; generating, by the server computer, a commitment object, the commitment object comprising the resource characteristics, the sender identifier, the receiver identifier, and a sequence identifier unique to the commitment object; and transmitting, by the server computer, a notification of commitment to the sender.

In some embodiments, the computer-readable medium 114D comprises code, executable by the processor 114B, to implement a method comprising: receiving, by a server computer from a sender device operated by a sender at an arbitrary location of a resource provider, of a plurality of resource providers, an assent request message comprising an indication of a plurality of resources at the resource provider; automatically creating, by the server computer, in response to the assent request message, a temporary resource provider module; providing, by the server computer, a plurality of temporary resource provider interfaces to a plurality of receiver devices in communication with the sender device; receiving, by the server computer, one or more commitment response messages from a set of receiver devices to commit to receiving resources, of the plurality of resources; processing, by the server computer, data to facilitate transfer of the resources to a set of receivers corresponding to the set of the receiver devices; and removing, after a predetermined time after the sender leaves the arbitrary location, by the server computer, an ability to access the temporary resource provider interfaces from that plurality of receiver devices.

The computer-readable medium 114D may comprise software code stored as a series of instructions or commands The computer-readable medium 114D may comprise an event management module 114F, an assertion management module 114G, a resource management module 114H, and a messaging module 114E.

The event management module 114F may include software configured to generate, store, and retrieve events. The event management module 114F may include code for generating events by collecting and parsing data associated with stages in an interaction (e.g., receipt of an assent request message or a commitment response message). The event management module 114F may include code for storing events to the identity database 116. The event management module may include code for accessing event information by querying the identity database 116 based on information such as a receiver identifier, a sender identifier, and/or a sequence identifier.

The assertion management module 114G may include software configured to create, store, and/or retrieve assertions 116D. As an example of the latter, the assertion management module 114G may, in conjunction with the processor 114B, query the identity database 116 with a receiver identifier 116C to identify and retrieve an interaction assertion 116E which specifies whether the receiver has a valid payment account on file.

The assertion management module 114G may include software to manage identifiers of senders and/or receivers. For example, the assertion management module 114G may include functionality to determine whether a receiver is part of the trusted identity network by determining whether an identifier of the receiver is stored to the identity database 116.

In some embodiments, the assertion management module 114G may include software that, when executed by the processor 114B, can generate assertions.

For example, the assertion management module 114G, in conjunction with the processor 114B, generates an assertion which specifies whether the first receiver 108A is old enough to buy alcohol in the location of the resource provider 120. The assertion management module 114G may, in conjunction with the processor 114B, determine a type of data suitable for generating an assertion (e.g., driver's license data; mortgage data). The assertion management module 114G may, in conjunction with the processor 114B, determine a data source for retrieving trusted identity data (e.g., from a bank or a government entity with trusted information validating processes). The assertion management module 114G may, in conjunction with the processor 114B, compute an assertion value, based on the retrieved trusted identity data. The assertion management module 114G may, in conjunction with the processor 114B, compute a trust score for an assertion, based on the source of data used to generate the assertion.

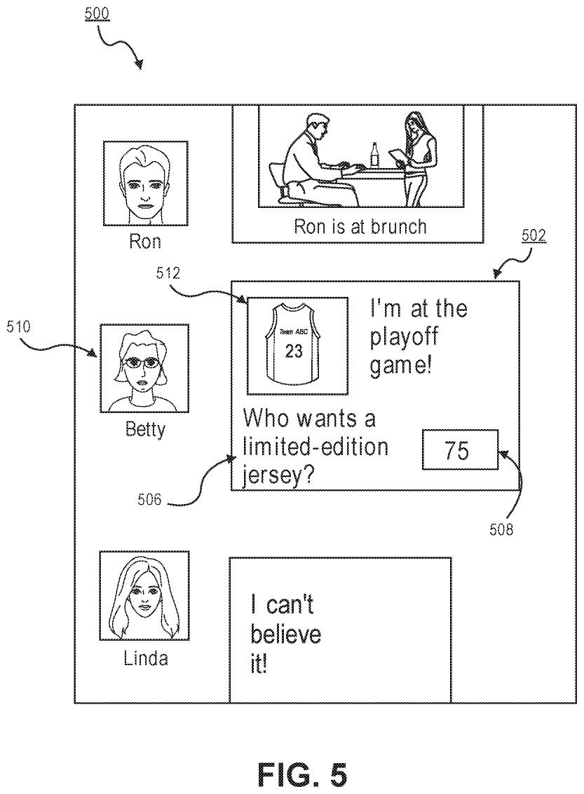

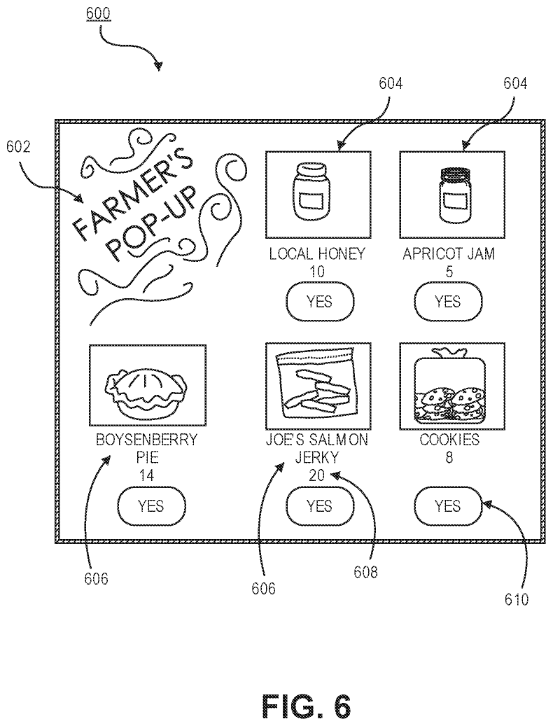

The resource management module 114H may include software configured to facilitate an interaction. The resource management module 114H may include code for generating assent request notifications. For example, the resource management module may, in conjunction with the processor 114B, package text describing a resource, a picture of the resource, and a link to commit to receiving the resource, into an assent request notification. The assent request notification may take different forms, including a short message service (SMS) message, an email, a social media post, and a resource provider interface. Example interfaces are shown in FIGS. 5 and 6.

The resource management module 114H may include software for facilitating transfer of a resource. The resource management module 114H may include code for managing shipment of a resource. The resource management module 114H may include code for setting up a meeting point to hand off a resource. The resource management module 114H may include code for payment processing. The resource management module 114H may, in conjunction with the processor 114B, generate and manage temporary resource provider modules 114J.

The temporary resource provider module 114J may include functionality to manage interactions for a plurality of resources for a particular sender. The temporary resource provider module 114J may include functionality described above with respect to the resource management module 114H, such as shipping and payment processing functionality. The temporary resource provider module 114J may be temporarily stored in association with the sender. The temporary resource provider module 114J may include code configured to facilitate interactions related to resources temporarily offered by the sender. The temporary resource provider module 114J may be restricted based on a particular location and/or time. For example, a temporary resource provider module 114J may be available while a sender is at a particular furniture store. As another example, a temporary resource provider module may be available for a twenty-four hour period. The temporary resource provider module 114J may include functionality to generate and manage a uniform resource locator (URL) for a temporary resource provider interface. The temporary resource provider module may temporarily associate an URL with a particular sender. After a condition (e.g., time or location) has expired, the temporary resource provider module 114J may disassociate the URL with the sender.

The messaging module 114E may comprise code for preparing and transmitting messages. The messaging module 114E may further be configured to accept and analyze messages. The messaging module 114E may include functionality to receive and transmit messages such as assent request messages and commitment response messages. The messaging module 114E may be configured to prepare and transmit messages to facilitate processing payment processing and/or the transfer of resources.

The interaction management computer 114 may further include data processing subsystems, networks, and operations used to support and deliver authorization services, exception file services, and clearing and settlement services. For example, the interaction management computer 114 may comprise a server coupled to a network interface (e.g., by an external communication interface), and databases of information. The interaction management computer 114 may be representative of a transaction processing network. An example transaction processing network may include VisaNet™. Transaction processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

### Methods

Managing an Interaction For a Resource

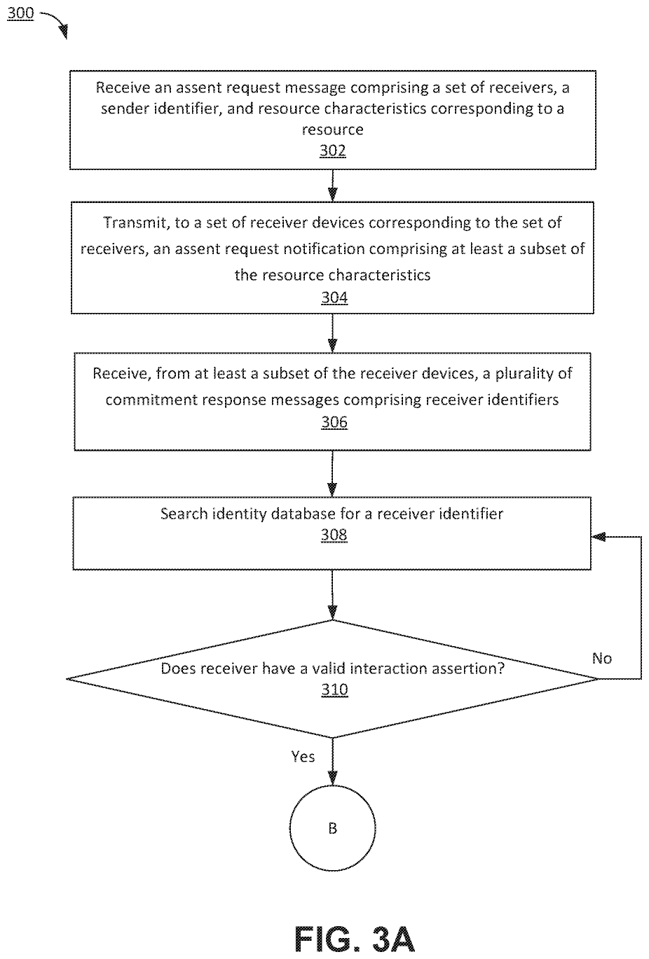

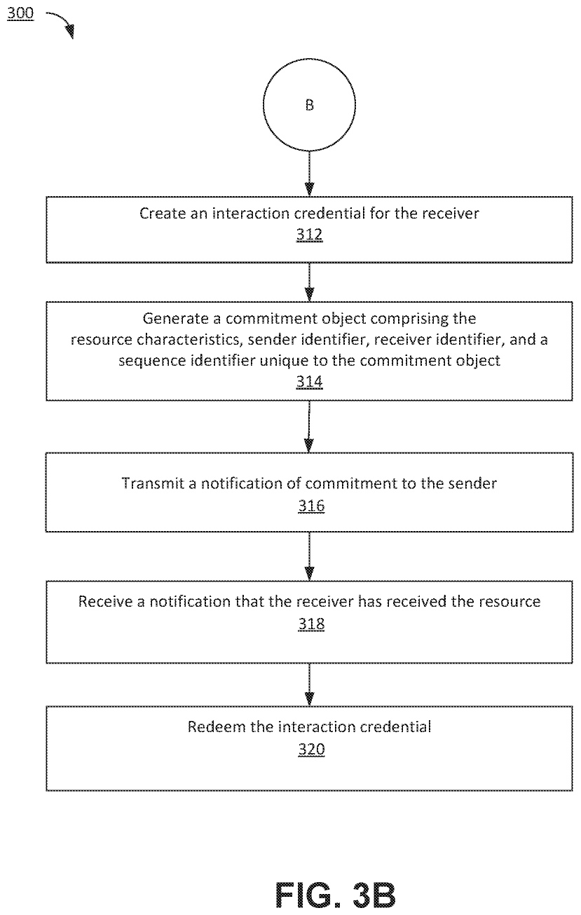

Referring now to FIGS. 3A-3B, a flow diagram of a method 300 for managing an interaction for a resource is shown according to a non-limiting embodiment.

At step 302, the interaction management computer receives an assent request message. The assent request message may be received from a sender via a sender device. Alternatively, or additionally, the assent request message may be transmitted from the sender device to a social network computer, which forwards the assent request message to the interaction management computer. The social network computer may, for example, transmit the assent request message to the interaction management computer via an API exposed by the interaction management computer. The assent request message may comprise a set of receivers (e.g., a list of contacts in a network of the sender). The assent request message may comprise a sender identifier of the sender. The interaction management computer may automatically retrieve a sender identifier from the sender device (e.g., by a pull by the interaction management computer or a push from the sender device). The assent request message may comprise resource characteristics corresponding to a resource. For example, the sender is at a farmer's market and sees some bread that looks fresh and appealing. The sender may take a picture of the bread via a camera on the sender device. The sender may, via the sender device, transmit a picture of the bread to the interaction management computer. The sender may further prepare and transmit a text description of the bread (e.g., “This bread looks great and is made from local grains! Who wants me to pick them up a loaf?”).

At step 304, the interaction management computer may generate and transmit an assent request notification comprising at least a subset of the resource characteristics. The interaction management computer may select a subset of the information in the received assent request message. The interaction management computer may package the subset of the information as a message (e.g., “Hi Judy, I'm at the concert, would you like me to pick you up a shirt for $50?”) or an advertisement (e.g., “Aquavit from Sweden available for a limited time only! Click here to secure a bottle.”). The assent request notification may include images. The assent request notification may include interface elements for accepting a response (e.g., a button or link with which a receiver may interact to commit to an interaction).

The interaction management computer may generate and transmit an assent request notification to one or more receiver devices. The interaction management computer may transmit the assent request notification to all, or a subset of, the receivers specified in the received assent request message. For example, the interaction management computer may filter out any potential receivers which are not part of the trusted identity network.

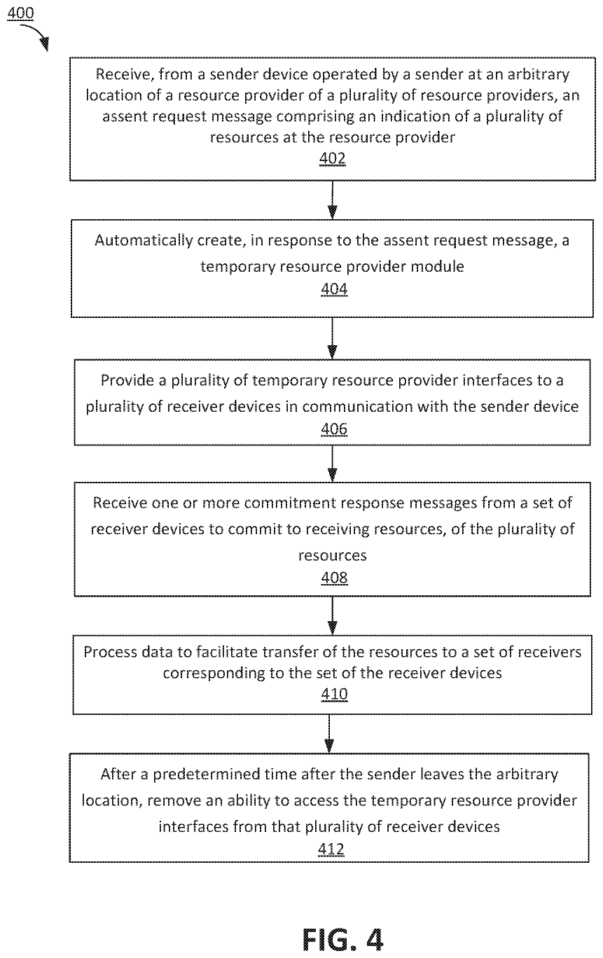

The interaction management computer may cause, directly or via the social network computer, display of the assent request notification on a receiver device. As an example, the interaction management computer may transmit an SMS or email message directly to a receiver device. As another example, the interaction management computer may transmit instructions to the social network computer, thereby causing the social network computer to generate, and cause display of, interface elements such as links, modals, images, text, etc., on a receiver device. An example assent request notification in the form of a social network post is shown in FIG. 5. As another example, the assent request notification may be displayed in the form of a temporary resource provider interface, as described in detail below with respect to FIGS. 4 and 6.

One or more receivers may interact with interfaces displaying assent request notifications. A receiver may initiate generation of a commitment response message by, for example, clicking on a button or URL displayed in the temporary resource provider interface. The commitment response message(s) may be generated and transmitted to the interaction management computer.

At step 306, the interaction management computer may receive a plurality of commitment response messages. The commitment response messages may be received from at least a subset of the receiver devices. For example, the assent request notifications may be transmitted to one-hundred people in the sender's social network. Out of those one-hundred people, eighty people may see the notification and twenty people may commit to the interaction. The receivers may, as examples, respond to an SMS message with an affirmative response (“I'd love one,” “yes,” “yea,” etc. may all trigger commitment) or click on an interface element (e.g., a button or link for commitment). The commitment response messages may include receiver identifiers identifying each of the respective receivers. The interaction management computer may automatically retrieve a receiver identifier from the receiver device (e.g., by a pull by the interaction management computer or a push from the receiver device).

At step 308, the interaction management computer may search the identity database for a receiver identifier. The interaction management computer may query the identity database for a receiver identifier received at step 306 to determine whether the received receiver identifier matches a receiver identifier stored to the identity database.

If there is no match to a stored receiver identifier, or no receiver identifier was retrieved for a particular receiver, then the interaction management computer may determine that a valid receiver identifier is not identified for the receiver. If a valid receiver identifier is not identified for the receiver, then the interaction management computer may transmit a message to the receiver prompting the receiver to join the trusted identity network. Alternatively, or additionally, the interaction management computer may transmit a message to the receiver indicating that the transaction cannot be completed, and cease the process for this receiver.

If a valid receiver identifier is identified for the receiver, then the interaction management computer may use the receiver identifier to retrieve one or more assertions about the receiver.

At step 310, the interaction management computer may determine whether the receiver has a valid interaction assertion. The interaction management computer may query the identity database to retrieve one or more assertions about the receiver. As described above with respect to FIG. 2A, an interaction assertion may assure that the receiver has a valid payment source on file. Alternatively, or additionally, the interaction management computer may retrieve additional assertions needed to proceed with an interaction. For example, an assent request message may specify conditions such as: a receiver must be local to the Chicago metropolitan area, over the age of 21, etc. The interaction management computer may identify assertions corresponding to the conditions.

In some embodiments, the interaction management computer may return a package of assertions about the receiver. Based on an identifier of the sender, the interaction management computer may identify a package of assertions for that type of sender. For example, in this context, the appropriate package of assertions may include (a) is the receiver a member of a whitelist, (b) is the receiver known to at least one other person in the group (i.e., has completed a transaction with another receiver, of the set of receivers), and (c) does the receiver have a valid payment token on file with at least $50 available in the corresponding account. The interaction management computer may generate the package of assertions as a singular yes or no answer. The interaction management computer may transmit the package of assertions to the sender.

If one or more of the required assertions are negative, then the process may stop for the receiver. The interaction management computer may return to step 308 to search the identity database for information about another receiver. This process may continue until all the receivers that sent commitment response messages have been evaluated.

Assertions can be used to provide increased security and privacy. The assertions may be stored and transmitted instead of specific personal data. Accordingly, even if the assertions are stolen in a breach of a storage system or intercepted over a network communication, sensitive personal data is not compromised.

Further, entities such as senders can use assertions to determine whether receivers have qualities required to enter into an interaction (e.g., a valid payment account) without receiving details about the receiver (e.g., account number or balance).

At step 312, the interaction management computer may create an interaction credential for the receiver. The interaction management computer may generate the interaction credential to be redeemable for something of value, subject to one or more conditions. For example, the interaction credential may be generated as a limited-value token which the sender may redeem for payment from an account of the receiver. The conditions may include an amount (e.g., the interaction credential may be redeemable for $15). Alternatively, or additionally, the conditions may include something the receiver must do (e.g., take a picture wearing shoes, trade a shirt for some sunglasses, or share candy with friends). The interaction credential may be restricted for a time period (e.g., if the resource is not provided to the receiver within 7 days, then the interaction credential may expire and no longer be redeemable).

At step 314, the interaction management computer may generate a commitment object. The commitment object may comprise information such as the resource characteristics, the sender identifier, and the receiver identifier. The interaction management computer may further generate a sequence identifier unique to the commitment object for inclusion in the commitment object. The commitment object may represent an obligation on the part of the sender and the receiver. For example, the sender is obligated to provide the resource and the receiver is obligated to pay for the resource. The commitment object may further include the interaction credential. The interaction management computer may store the commitment object to the identity database. The commitment object may be stored as an event.

At step 316, the interaction management computer may transmit a notification of commitment to the sender. For example, the interaction management computer may transmit information to the sender device to facilitate sending the resource to the receivers that have committed and been validated. Such information may include the receiver's name, address, and/or phone number. Alternatively, or additionally, the notification of commitment may indicate a number of confirmed receivers.

Upon receiving one or more notifications of commitment, the sender may procure the appropriate number of resources. As an example, if the notification of commitment indicated five receivers were cleared to receive a handmade bracelet for $75 each, then the sender may make five bracelets. The sender may then provide the resources to the receivers. The sender may, for example, mail the resources and/or deliver resources to the receivers. As another example, the notification of commitment indicates ten receivers which are to receive access to a secure data set. The sender may grant the ten receivers access to the secure data set (e.g., by releasing a key or password).

At step 318, the interaction management computer may receive a notification that the receiver has received the resource. The notification may be generated on a receiver device (e.g., the receiver may interact with an interface element to indicate that the resource has been received). Alternatively, or additionally, the notification may be generated on the sender device (e.g., the sender may interact with an interface element to indicate that the sender delivered the resource to the receiver). As another example, the notification may be received from a delivering entity (e.g., a freight company or postal service may link an internal tracking system to an API exposed by the interaction management computer so that the interaction management computer receives the notification when the resource has been delivered). The notification may be sent to the interaction management computer directly or via the social network computer.

At step 320, the interaction management computer may redeem the interaction credential. The interaction management computer may delete the interaction credential or deactivate the interaction credential. If the recipient is to pay for the resource, then the interaction management computer may initiate payment processing. Initiating payment processing may include executing payment processing operations, and/or transmitting instructions to proceed with payment processing operations to a payment processing computer. As an example, the interaction management computer may initiate payment processing via a direct payment service

Direct payment may comprise an Account Funding Transaction (AFT)/Original Credit Transaction (OCT) process. In an AFT/OCT process, an AFT message is first sent to a payer's bank (e.g., an authorizing entity computer associated with the receiver). After the AFT message is approved by the payer's bank, an OCT message is transmitted to the payee's bank (e.g., an authorizing entity computer associated with the sender).

An AFT (Account Funding Transaction) is a transaction designed to supply funds from one payment account to another account (e.g., a credit, prepaid, debit, ATM or on-line account). An AFT may correspond to paying a payee (e.g., a sender) for providing a resource to a payer (e.g., a receiver). The AFT may result in a debit to the payer's account. Authorization and clearing operations may be executed without carrying financial information about the payee. The AFT carries only the account number associated with the payment account of the payer. An AFT is also accompanied by indicators, which allow the sender's issuing bank to take appropriate authorization decisions. Indicators include channel information such as Mail Order/Telephone Order or Internet, and merchant type. AFT indicators are used to show funds transfers instead of standard purchase transactions.

An OCT is typically a clearing and settlement credit transaction designed for use in business applications such as a business money transfer or business-to-consumer repayments. OCT may be used to deliver funds to the payee account. It is separate from, and takes place after, the AFT transaction. This timing is to ensure that payment funds are secured before funds are sent to the payee. In some embodiments, the OCT carries only the account number of the payee and no information about the payer. A special indicator identifies an OCT to the payee's issuer bank.

In some embodiments, the sender and/or receiver may be notified when payment processing is complete. For example, the interaction management computer may transmit notification(s) to a sender device and/or receiver device.

In some embodiments, one of the parties to the transaction may initiate a dispute. For example, the receiver may claim to have not received access to the resource or the sender may claim to have not received payment. The interaction management system may handle the dispute using events stored in the identity database, as these events specify steps in the interaction that have been completed. For example, using the unique sequence identifier for a commitment object, the interaction management system may identify a set of events associated with the interaction which are stored to the identity database. Based on the set of events, the interaction management system may determine that there are stored events corresponding to a request for assent, a commitment response, the resource being delivered to the receiver, and payment initiation. The interaction management system may use details of the payment initiation event to determine that the payment transaction was declined, and attempt to reinitiate payment to resolve the dispute. The dispute may be stored as an event in the identity database.

The interactions may take various forms. As an example, a sender may be at a concert and offer to pick up shirts for friends. The sender may pick up shirts for friends that agree to pay for them, and collect payment on delivery of the shirts. As another example, a sender is shopping online and sees a great sale on shoes. She buys ten pairs at the sale price and offers the shoes to friends. As another example, a sender is running a pop-up jewelry stand. He has a limited selection of crystal watches, about which he sends out a blast to his social network. As another example, an interior designer is at a store selling home decor. She takes a picture of throw pillows and posts to her social network, asking if anyone wants her to pick one up and pay her back at $30. Attached to her post are business information and contact information, which allows her to advertise her services to the network. As another example, a small business has extra inventory he needs to sell and has an online presence. He uses the interaction management system to extend an offer to his social network.

Advantageously, the interaction can be managed in an open-loop fashion from start-to-finish. Because the interaction is not limited to a particular platform (e.g., a particular online marketplace or the like), the sender can leverage one or more platforms to distribute a request for assent to multiple networks (e.g., through all the sender's social media accounts). Accordingly, such functionality can increase visibility of the sender's request for assent, creating an increased set potential receivers. This may, in turn, increase exposure and/or revenue for the sender. Further, via the use of an interaction credential and validation within the trusted identity network, the fear of not being compensated is removed for both the sender and the receiver.

Managing an Interaction for a Plurality of Resources

Referring now to FIG. 4, a flow diagram of a method 400 for managing an interaction for a plurality of resources is shown according to a non-limiting embodiment.

At step 402, the interaction management computer may receive an assent request message from a sender device operated by a sender. The assent request message may be received from the sender device directly or via the social network computer.

The sender device may be at an arbitrary location of a resource provider, of a plurality of resource providers. As examples, the sender may be in a store, at a merchandise table, at a location of a service provider, or the like. The assent request message may comprise an indication of a plurality of resources at the resource provider. For example, the sender may be at a souvenir shop in Hawaii, and the assent request message may include several items available in the shop—T-shirts, keychains, macadamia nuts, Kona coffee, and snow globes.

At step 404, the interaction management computer may automatically create, in response to the assent request message, a temporary resource provider module. The interaction management computer may generate software elements for managing interactions between the sender and a set of receivers, corresponding to the plurality of resources at the resource provider specified by the sender.

At step 406, the interaction management computer may provide a plurality of temporary resource provider interfaces to a plurality of receiver devices in communication with the sender device. The interaction management computer may provide the interfaces by transmitting instructions for rendering interface elements. Rendering the interface elements may be performed by the receiver device, the social network computer, and/or the interaction management computer. For example, the interaction management computer may transmit instructions to the social network computer, which specify text and images to display. The social network computer may cause display, on the plurality of receiver devices, of native social network elements with a modal comprising the temporary resource provider interface. As another example, the interaction management computer may transmit instructions for rendering interface elements directly to a receiver device. The receiver device may then render the interface elements according to the instructions (e.g., in a Web browser or an application associated with the interaction management system).

The temporary resource provider interfaces may include information about each of the resources (e.g., text description, pictures, etc.). An example temporary resource provider interface is shown in FIG. 6.

One or more receivers may interact with temporary resource provider interface(s). A receiver may initiate generation of a commitment response message by, for example, clicking on a button or URL displayed in the temporary resource provider interface. The commitment response message(s) may be generated on a receiver device and transmitted to the interaction management computer.

At step 408, the interaction management computer may receive one or more commitment response messages from a set of receiver devices to commit to receiving resources, of the plurality of resources. The interaction management computer may receive the commitment response messages from the receiver devices corresponding to those receives that interacted with the temporary resource provider interface (e.g., by clicking on a button or link to indicate assent).

At step 410, the interaction management computer may process data to facilitate transfer of the resources to a set of receivers corresponding to the set of receiver devices. Processing data to facilitate transfer of the resources to the receivers may comprise processing payment. For example, the interaction management computer may use Visa Direct® to collect an amount corresponding to the resource. Processing data to facilitate transfer of the resources may include retrieving a delivery location (e.g., a receiver address). Processing data to facilitate transfer of the resources may include shipping operations such as setting up shipping with a provider, determining shipping timelines, etc.

At step 412, after a predetermined time after the sender leaves the arbitrary location, the interaction management computer may remove an ability to access the temporary resource provider interfaces from that plurality of receiver devices. Determining that the sender leaves the arbitrary location may comprise determining that the sender is out of a particular range of the location and/or determining that the sender has been away from the location for a particular time period. For example, the system may demine that the sender has left an arbitrary location if the sender has been over 500 yards from the location for more than an hour.

The interaction management system may continuously or periodically monitor a location of the sender. The interaction management system may monitor the sender's location using, for example, location functionality of the sender device such as GPS. Upon determining that the sender has left the arbitrary location, the system may perform functions such as removing user access to the interface and/or deleting or overwriting the temporary resource provider module.

Beneficially, the interaction management system can provide a temporary resource provider interface, allowing the sender to offer unique items, in addition to executing payment processing operations for the sender. Using a temporary resource provider interface, the sender can easily offer resources for sale on the go. Wherever the sender may be, the sender can open up a “pop-up shop” in moments.

Example Interfaces

FIG. 5 is an example interface 500 according to some embodiments. The interface 500 may be part of a feed generated by a social media provider, to show updates from a set of users that are in the social network of a receiver. Interface 500 may be displayed on a receiver device. The interface 500 may include sender information 510 and an assent request notification 502.

The sender information 510 may identify the sender, e.g., with a name and/or picture. As shown in FIG. 5, the sender is identified by name (“Betty”), as well as with a picture of the sender. The assent request notification 502 includes a photograph 512 of the resource, a textual description of the resource 506, and a button 508.

The textual description of the resource 506 includes resource characteristics specifying that the resource is a limited-edition jersey. The textual description of the resource 506 further specifies that the sender is at a playoff game, indicating that the sender has a limited time to procure the resource.

The button 508 includes the price of the resource requested by the sender (“$75”). When the receiver clicks the button 508, a commitment response message may be generated and transmitted to the interaction management system.

FIG. 6 illustrates an example interface 600. The interface 600 may include information about a plurality of resources offered by a sender. The interface 600 may be displayed on a receiver device. The interface 600 may include a name of the interface 602, images of the resources 604, descriptions of the resources 606, prices of the resources 608, and buttons 610 for initiating a commitment response for the resources.

The interface 600 may correspond to a temporary resource provider interface generated when a sender is at a farmer's market (e.g., a location of a resource provider, of a plurality of resource providers). The sender may take snapshots of various resources, such as honey, apricot jam, pie, jerky, and cookies, as shown in FIG. 6. Accordingly, the pictures 604 can show how the resources appear in real-time (e.g., the pie is freshly baked). Alternatively, or additionally, the interface 604 may include additional photos and/or videos corresponding to one or more of the resources. For example, the interface may include elements for scrolling through a set of pictures 604 of a resource. As another example, the interface may display a video that the sender took panning over a long line of buyers, indicating how in-demand the cookies at the farmer's market are.

Each button 610 may, when interacted with by a receiver, initiate generation of a commitment response message. For example, a receiver may click on the “yes” button by the apricot jam, thereby causing the transmission of a commitment response message to the interaction management system.

Advantages; Extensions

The teachings of this disclosure have a number of advantages. Through the use of an interaction credential, the fear of not being compensated is removed. In contrast to prior methods (e.g., placing a hold on an account or placing funds in escrow), the funds of the receiver are not affected until the receiver has received the resource. Additionally, the system can automatically determine whether receivers and senders are part of the trusted identity network. Further, the system may include dispute management functionality. Thus, the trusted identity platform can give users confidence to enter into different kinds of resource-based interactions. This can open up the world of resource-based interactions beyond traditional channels.

Embodiments have a number of additional advantages. For example, some embodiments provide heightened privacy through the use of assertions. A package of assertions can be used to determine whether receivers have qualities required to enter into an interaction (e.g., a valid payment account, a particular age, a particular state of residence) without divulging details about the receivers.

Embodiments have a number of additional advantages. An existing social network can be leveraged to increase visibility of a request for assent. This can be integrated with other functionality, such as advertising, posting pictures and videos, and so forth.

Further, embodiments provide an open-loop system for brokering an interaction start-to-finish. Because the interaction is not limited to a particular platform (e.g., a particular online marketplace or the like), the sender can leverage one or more platforms to distribute a request for assent to multiple networks (e.g., through all the sender's social media accounts). Further, the interaction can proceed without the friction of going to a website or application for making payments, selecting goods, or the like. The interaction can proceed to delivering a resource, settlement, and potential dispute, all in an open-loop fashion.

It should be understood that any of the embodiments be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices.

Such programs may also be encoded and transmitted using carrier signals adapted for transmission via wired, optical, and/or wireless networks conforming to a variety of protocols, including the Internet. As such, a computer-readable medium according to an embodiment may be created using a data signal encoded with such programs. Computer readable media encoded with the program code may be packaged with a compatible device or provided separately from other devices (e.g., via Internet download). Any such computer-readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the embodiments will become apparent to those skilled in the art upon review of the disclosure. The scope of the embodiments should, therefore, be determined not with reference to the above description, but instead should be determined with reference to the pending claims along with their full scope or equivalents.

Although embodiments have been described in detail for the purpose of illustration based on what is currently considered to be the most practical and preferred embodiments, it is to be understood that such detail is solely for that purpose and that the teachings of this disclosure are not limited to the disclosed embodiments, but, on the contrary, are intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

One or more features from any embodiment may be combined with one or more features of any other embodiment without departing from the teachings of this disclosure.

As used herein, the use of “a,” “an,” or “the” is intended to mean “at least one,” unless specifically indicated to the contrary.

What is claimed is:

1. A method comprising:
receiving, by a server computer from a sender device operated by a sender, an assent request message corresponding to an interaction, the assent request message comprising a set of receivers, a sender identifier, and resource characteristics corresponding to a resource;
transmitting, by the server computer to a set of receiver devices, each receiver device, of the set of receiver devices, corresponding to a receiver, of the set of receivers, an assent request notification comprising at least a subset of the resource characteristics;
receiving, by the server computer from at least a subset of the set of receiver devices, a plurality of commitment response messages to commit to receiving the resource, wherein each commitment response message, of the plurality of commitment response messages, comprises a receiver identifier, of a plurality of unique receiver identifiers;
for at least one commitment response message, of the plurality of commitment response messages:
searching, by the server computer, an identity database for the receiver identifier;
based on the receiver identifier, determining, by the server computer, whether a valid interaction assertion exists for the receiver;
if the valid interaction assertion exists for the receiver,
creating, by the server computer, an interaction credential for the receiver;
generating, by the server computer, a commitment object, the commitment object comprising the resource characteristics, the sender identifier, the receiver identifier, and a sequence identifier unique to the commitment object; and
transmitting, by the server computer, a notification of commitment to the sender, indicating that the receiver will proceed with the interaction.

2. The method of claim 1, further comprising:
receiving, by the server computer, a notification that the receiver has received the resource; and
redeeming, by the server computer, the interaction credential.

3. The method of claim 1, further comprising: generating and storing to the identity database, by the server computer, an event corresponding to the commitment object.

4. The method of claim 1, wherein the interaction credential is restricted based on one or more of a time or an amount.

5. The method of claim 1, wherein the assent request message is initially received by a social network computer which forwards the assent request message to the server computer.

6. The method of claim 1, wherein the assent request message further comprises one or more conditions and the method further comprises determining, by the server computer by querying the identity database, whether the one or more conditions are met.

7. The method of claim 1, wherein the assent request notification is transmitted at least in part by initiating display of an interface comprising one or more of an image or an interface element for generating a commitment response message.

8. A server computer comprising:
a processor; and
a non-transitory computer-readable medium coupled to the processor, the non-transitory computer-readable medium comprising code, executable by the processor, to implement a method comprising:
receiving, by the server computer from a sender device operated by a sender, an assent request message corresponding to an interaction, the assent request message comprising a set of receivers, a sender identifier, and resource characteristics corresponding to a resource;
transmitting, by the server computer to a set of receiver devices, each receiver device, of the set of receiver devices, corresponding to a receiver, of the set of receivers, an assent request notification comprising at least a subset of the resource characteristics;
receiving, by the server computer from at least a subset of the set of receiver devices, a plurality of commitment response messages to commit to receiving the resource, wherein each commitment response message, of the plurality of commitment response messages, comprises a receiver identifier, of a plurality of unique receiver identifiers;
for at least one commitment response message, of the plurality of commitment response messages:
searching, by the server computer, an identity database for the receiver identifier;
based on the receiver identifier, determining, by the server computer, whether a valid interaction assertion exists for the receiver;
if the valid interaction assertion exists for the receiver,
creating, by the server computer, an interaction credential for the receiver;
generating, by the server computer, a commitment object, the commitment object comprising the resource characteristics, the sender identifier, the receiver identifier, and a sequence identifier unique to the commitment object; and
transmitting, by the server computer, a notification of commitment to the sender, indicating that the receiver will proceed with the interaction.

9. The server computer of claim 8, the method further comprising:
receiving, by the server computer, a notification that the receiver has received the resource; and
redeeming, by the server computer, the interaction credential.

10. The server computer of claim 8, the method further comprising:
generating and storing to the identity database, by the server computer, an event corresponding to the commitment object.

11. The server computer of claim 8, wherein the interaction credential is restricted based on one or more of a time or an amount.

12. The server computer of claim 8, wherein the assent request message is initially received by a social network computer which forwards the assent request message to the server computer.

13. The server computer of claim 8, wherein the assent request message further comprises one or more conditions and the method further comprises determining, by the server computer by querying the identity database, whether the one or more conditions are met.

14. The server computer of claim 8, wherein the assent request notification is transmitted at least in part by initiating display of an interface comprising one or more of an image or an interface element for generating a commitment response message.

15. A method comprising:
receiving, by a server computer from a sender device operated by a sender at an arbitrary location of a resource provider, of a plurality of resource providers, an assent request message comprising an indication of a plurality of resources at the resource provider;
automatically creating, by the server computer, in response to the assent request message, a temporary resource provider module;
providing, by the server computer, a plurality of temporary resource provider interfaces to a plurality of receiver devices in communication with the sender device;
receiving, by the server computer, one or more commitment response messages from a set of receiver devices to commit to receiving resources, of the plurality of resources;
processing, by the server computer, data to facilitate transfer of the resources to a set of receivers corresponding to the set of the receiver devices; and
removing, after a predetermined time after the sender leaves the arbitrary location, by the server computer, an ability to access the temporary resource provider interfaces from that plurality of receiver devices.

16. The method of claim 15, wherein processing the data to facilitate transfer of the resources comprises:
creating, by the server computer, an interaction credential corresponding to a receiver, of the set of receivers;
receiving, by the server computer, a notification that the receiver has received the resource; and
redeeming, by the server computer, the interaction credential.

17. The method of claim 15, wherein the method further comprises generating and storing to an identity database, by the server computer, an event corresponding to the transfer of the resources.

18. The method of claim 15, wherein the assent request message is initially received by a social network computer which forwards the assent request message to the server computer.

19. The method of claim 15, wherein the assent request message further comprises one or more conditions and the method further comprises determining, by the server computer by querying an identity database, whether the one or more conditions are met.

20. The method of claim 15, wherein the temporary resource provider interfaces comprise one or more of an image or an interface element for generating a commitment response message.
